(19) United States
(12) Patent Application Publication
(10) Pub. No.: US 2024/0390207 A1
(43) Pub. Date: Nov. 28, 2024

(54) Link lever assembly, dual-link-lever fixing assembly and surgical head frame

(71) Applicant: BEIJING HONGHUGAOXIANG TECHNOLOGY DEVELOPMENT CO., LTD, Beijing (CN)

(72) Inventors: Bing WANG, Beijing (CN); Qingguo MENG, Chaoyang City, Liaoning (CN)

(21) Appl. No.: 18/259,594

(22) PCT Filed: Nov. 7, 2022
(86) PCT No.: PCT/CN2022/130201

§ 371 Date: Jun. 28, 2023

(30) Foreign Application Priority Data
Apr. 13, 2022 (CN) 202210388178.2

(51) Int. Cl. A61G 13/12

(52) U.S. Cl. CPC A61G 13/121; A61G 13/1295

(57) ABSTRACT

A link-lever assembly, dual-link-lever fixing assembly and surgical head frame, aims to address the problem that installation and connection of U-shaped head frames and operational tables takes a long time, manufacturing cost of the connection pieces is high and it is not easy to maintain them. The present invention provides a dual-joint link-lever, comprises a first connection ring, a first pressing panel, a second connection ring, a second pressing panel and a connection plate; the first connection ring and the second connection ring are provided to both ends of the connection plate along a longitudinal direction, and axial lines of the first connection ring and the second connection ring are parallel; and upon extrusion the first pressing panel and the second pressing panel are configured to drive diameters of the first annular hole and the second annular hole to be smaller.

### TECHNICAL FIELD

The present invention relates to the technical field of medical devices and especially to a link lever assembly, dual-link-lever fixing assembly and surgical head frame.

### BACKGROUND TECHNOLOGY

U-shaped head frames and intermediate connection devices of operation table installations currently available comprise usually locking devices, toothed link levers and rotational connectors, after assembly, the intermediate connection devices can be rotated for 360°, and can realize connection between the U-shaped head frames and the operation table installations. During use, it is necessary to lock one place with a handle, connect two places with another handle and screws, that is, to fix three places, and the problem with the connection structure is that it takes a long time for connecting with the handles and the screws, manufacturing cost of elements of the locking devices and the rotational connectors is high, and it is not easy to maintain the connection structure.

### SUMMARY OF THE INVENTION

A purpose of the present invention is to provide a link-lever assembly, dual-link-lever fixing assembly and surgical head frame, to address the problem that it takes a long time to install and connect the U-shaped head frame and operational tables, manufacturing cost of the connection pieces is high and it is difficult to maintain the parts.

To address the foregoing problem, the technical solutions provided in the present invention are that:

The present invention provides a link-lever assembly, comprising a dual-joint link-lever and a guiding rod, wherein the guiding rod comprises a ring portion and a rod portion;

The dual-joint link-lever comprises a first connection ring, a first pressing panel, a second connection ring, a second pressing panel and a connection plate; the first connection ring and the second connection ring are provided at both ends along a longitudinal direction of the connection plate, and the first connection ring and the second connection ring are axially parallel; the first pressing panel is provided at a side of the connection plate in a thickness direction and an end portion of the first pressing panel is connected with the first connection ring, a first locking joint communicating with a first annular hole of the first connection ring is formed in between the first pressing panel and the connection plate; the second pressing panel is provided at another side of the connection plate in the thickness direction, and an end portion of the second pressing panel away from the first pressing panel is connected with the second connection ring, and a second locking joint communicating with a second annular hole of the second connection ring is provided in between the second pressing panel and the connection plate; the first pressing panel and the second pressing panel are configured to reduce the diameters of the first annular hole and the second annular hole by pressing forces acting in opposite directions;

At least one connection hole is provided on the ring portion, a third locking joint extending along an axial direction of the rod portion is provided on the rod portion, and the third locking joint is communicated with the at least one connection hole; the rod portion is inserted into the second connection ring; the rod portion is configured to reduce the size of the third locking joint when being pressed and thereby reduces a diameter of the at least one connection hole of the ring portion.

Further, a width of the first locking joint increases gradually along a direction away from the first connection ring; and a width of the second locking joint gradually increases along a direction away from the second connection ring.

Further, a first annular joint is provided circumferentially around the first connection ring, the first annular joint separates the first connection ring into two ring bodies along a width direction; and a second annular joint is provided circumferentially around the second connection ring, and the second annular joint divides the second connection ring into two ring bodies along a width direction.

Further, the link-lever assembly comprises further a handle and connection screws; the connection screws pass sequentially the second pressing panel, the connection plate and the first pressing panel, and the axis of the connection screws are perpendicular to the axis of the first connection ring in a horizontal plane; one end of the handle is hingedly connected with ends of the connection screws, a cam structure is provided at an end wherein the handle is hingedly connected with the connection screws and the cam structure is abutted to the second pressing panel.

Further, the link-lever assembly comprises a limiting pin, the limiting pin is inserted in the handle; the limiting pin is slidably connected with the handle and is configured to be able to be inserted into both the handle and the connection screws to prevent the handle from rotating. The present invention provides a dual-link-level fixing assembly, comprises the forgoing link-lever assemblies, comprises further a steering column; wherein the steering column is provided in between two link-lever assemblies, and both ends of the steering column are respectively connected with the two link-lever assemblies; connection shafts are provided at both ends of the steering column, the axes of the two connection shafts are perpendicular to each other; and the two connection shafts are inserted into connection holes in the two link-lever assemblies.

Further, at least one annular groove is provided on the connection shafts, threaded holes are opened at side surfaces of the connection holes; and fixing screws are inserted into the threaded holes and inserted into the at least one annular groove.

Further, the dual-link-lever fixing assembly comprises further a gear shaft; a side of the gear shaft is inserted into the first connection ring of one of the link-lever assemblies; and a surface of another side of the gear shaft is configured to be tooth-shaped and to be connected with a U-shaped head frame.

The present invention further provides a surgical head frame, comprising the foregoing dual-link-lever fixing assembly; wherein one end of the dual-link-lever fixing assembly is connected with the U-shaped head frame and another end thereof is connected with an operational table.

In view of the foregoing technical solutions, technical effects that the present invention can realize are that:

The present invention provides a link-lever assembly; wherein the link-lever assembly comprises a two-joint link-lever and a guiding rod, wherein the guiding rod comprises a ring portion and a rod portion;

Wherein, the two-joint link-lever comprises a first connection ring, a first pressing panel, a second connection ring, a second pressing panel and a connection plate; the first connection ring and the second connection ring are provided at both ends of the connection plate along a longitudinal direction, and axial lines of the first connection ring and the second connection ring are parallel; the first pressing panel is provided at a side of the connection plate along a thickness direction and end portions of the first pressing panel is connected with the first connection ring, and a first locking joint communicating with a first annular hole of the first connection ring is formed in between the first pressing panel and the connection plate; the second pressing panel is provided at another side of the connection plate along the thickness direction, and an end portion of the second pressing panel away from the first pressing panel is connected with the second connection ring, and a second locking joint communicating with the second connection ring is formed in between the second pressing panel and the connection plate; and the first pressing panel and the second pressing panel are configured to drive diameters of the first annular hole and the second annular hole to be smaller upon extrusion by extruding forces in opposite directions.

With the dual-joint link-lever provided in the present invention, by pressing at the same time the first pressing panel and the second pressing panel to reduce the diameters of the first annular hole and the second annular hole, with only one operation the shafts in the first annular hole and the second annular hole can be locked. In conventional technologies, by one operation only structures of a shaft can be locked and to connect two shafts, two operations are required to lock the two shafts. In comparison, with the dual-joint link-lever the locking operations are simplified, in the meanwhile the number of elements is reduced, the connection structure is simplified, installation time is reduced efficiently, manufacturing cost of the connection pieces is reduced and maintainability is improved.

### BRIEF DESCRIPTION OF DRAWINGS

To explain the technical solutions in the embodiments or the prior art more clearly, hereinafter a brief introduction is given to the drawings to be used in description of the embodiments or the prior art, obviously, the drawings given show only some embodiments of the present invention, and for of ordinary skill in the art, without paying creative effort, it is possible to obtain other drawings with the provided drawings.

FIG. 1 is a front view of a link-lever assembly provided in an embodiment of the present invention;

FIG. 2 is an A-A sectional diagram showing the link-lever assembly provided in an embodiment of the present invention;

FIG. 3 is a structural diagram showing a dual-joint link-lever in the link-lever assembly provided in an embodiment of the present invention;

FIG. 4 is a structural diagram showing the dual-joint link-lever in the link-lever assembly provided in an embodiment of the present invention;

FIG. 5 is a structural diagram showing a guiding rod;

FIG. 6 is a structural diagram showing a handle;

FIG. 7 is a structural diagram showing a steering column;

FIG. 8 is a structural diagram showing a gear shaft;

FIG. 9 is a structural diagram showing a surgical head frame according to an embodiment of the present invention; and

FIG. 10 is a structural diagram showing the surgical head frame according to an embodiment of the present invention.

In the drawings: 100—link-lever assembly; 200—steering column; 300—gear shaft; 110—dual-joint link-lever; 120—guiding rod; 130—handle; 140—connection screw; 150—limiting pin; 210—connection pin; 220—connection handle; 111—first connection ring; 112—first pressing panel; 113—second connection ring; 114—second pressing panel; 115—connection plate; 116—locking hole; 121—ring portion; 122—rod portion; a—first annular hole; b—second annular hole; c—first locking joint; d—second locking joint; e—first annular joint; f—second annular joint; g—connection hole; h—third locking joint; k—limiting groove; and m—annular groove.

### EMBODIMENTS

To make the purpose, technical solutions and advantages of the present invention more clear, hereinafter a clear and complete description will be given to the technical solutions in the embodiments of the present invention in conjunction with the drawing accompanying the present invention, apparently, the embodiments given here are only some of the embodiments of the present invention rather than all. Usually elements described and shown in the following embodiments and the drawings can be laid out and designed in many different configurations. Hereafter in combination with the accompanying drawings, some embodiments of the present invention will be described in detail. When no conflict will occur, embodiments or features in the following embodiments can be combined with each other.

### Embodiment 1

For U-shaped head frames and operational tables, it takes a long time to install and connect the same, manufacturing cost of connection pieces is high and it is not easy to maintain properly the U-shaped head frames and the operational tables.

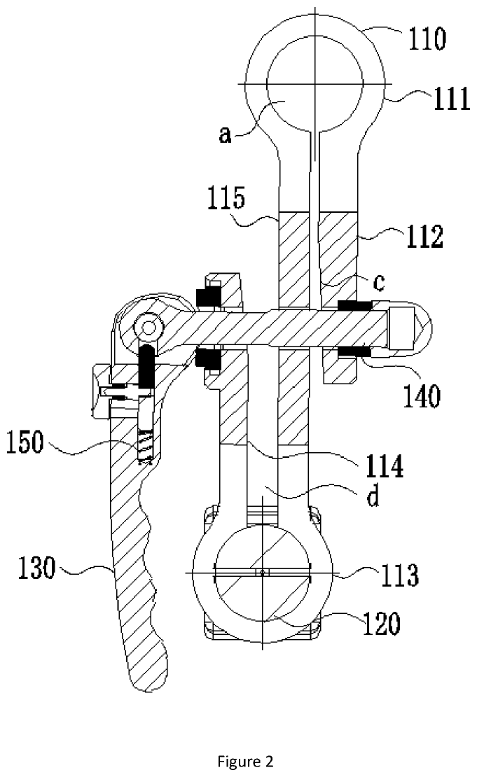

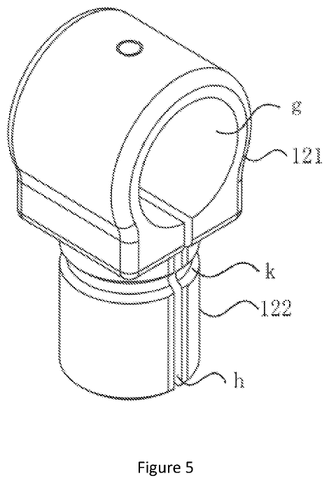

An embodiment of the present invention provides a link-lever assembly 100, comprises a dual-joint link-lever 110 and comprises further a guiding rod 120. As shown in FIGS. 2 and 5, the guiding rod 120 comprises a ring portion 121 and a rod portion 122;

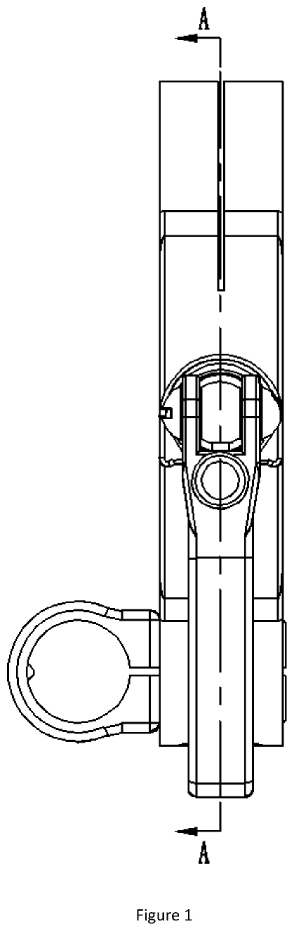

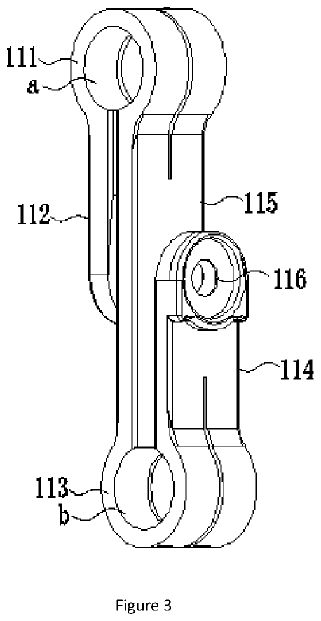

In the meanwhile, please refer to FIGS. 1-3, the dual-joint link-lever 110, comprises a first connection ring 111, a first pressing panel 112, a second connection ring 113, a second pressing panel 114 and a connection plate 115; the first connection ring 111 and the second connection ring 113 are provided at both ends of the connection plate 115 along a longitudinal direction, and axial lines of both the first connection ring 111 and the second connection ring 113 are parallel; the first pressing panel 112 is provided at a side of the connection plate 115 along a thickness direction, and is connected with the first connection ring 111, and a first locking joint c communicating with a first annular hole a of the first connection ring 111 is formed in between the first pressing panel 112 and the connection plate 115; the second pressing panel 114 is provided at another side of the connection plate 115 along the thickness direction and an end portion of the second pressing panel 114 away from the first pressing panel 112 is connected with the second connection ring 113, and a second locking joint d communicating with a second annular hole b of the second connection ring 113 is formed in between the second pressing panel 114 and the connection plate 115; and the first pressing panel 112 and the second pressing panel 114 are configured to drive diameters of the first annular hole a and the second annular hole b to be smaller upon extrusion in opposite directions;

At least one connection hole g is provided on the ring portion 121, a third locking joint h extending along an axial direction of the rod portion 122 is provided on the rod portion 122, and the third locking joint h is communicated with the at least one connection hole g; the rod portion 122 is inserted into the second connection ring 113; and the rod portion 122 is configured to drive diameters of the ring portion 121 to be smaller by driving the third locking joint h to be smaller upon extrusion.

By analyzing the technical solution, it can be known that: for the dual-joint link-lever 110, by pressing simultaneously the first pressing panel 112 and the second pressing panel 114 diameters of the first annular hole a and the second annular hole b are reduced, in this way, with only one operation, the shafts in the first annular hole a and the second annular hole b can be locked. In conventional technologies, with one operation only one shaft can be fixed, and to connect two shafts two operations are required to respectively lock the two shafts. In comparison, the dual-joint link-lever 110 provided in the present invention has simplified locking operations, in the meanwhile, reduced the number of elements, simplified connection structures, shortened installation time, reduce manufacturing cost of the connection pieces and improved maintainability.

Hereinafter with reference to FIGS. 1-4, a detailed description is given to structures and configurations of the dual-joint link-lever 110.

In an optional technical solution, a width of the first locking joint c increases gradually along a direction away from the first connection ring 111, a width of the second locking joint d increases gradually along a direction away from the second connection ring 113, therefore, when the first pressing panel 112 and the second pressing panel 114 are pressed upon, diameters of the first annular hole a and the second annular hole b are reduced, locking force on the shafts in the first annular hole a and the second annular hole b are increased and the connection is more reliable. Further, a first annular joint e is provided circumferentially around the first connection ring 111, and the first annular joint e divides the first connection ring 111 to be two ring bodies along a width direction; a second annular joint f is provided circumferentially around the second connection ring 113, the second annular joint f divides the second connection ring 113 to be two ring bodies along a width direction, so that inner surfaces of the first connection ring 111 and the second connection ring 113 contact fully the shafts inserted therein and friction is improved to prevent the shafts from rotation.

Further, at least one annular locating groove k is provided on the rod portion 122 and is configured to locate the dual-joint link-lever 110.

Specifically, the guiding rod 120 is made from aluminum alloy to reduce weight and make it easy to claim and use it.

In the present embodiment, a width of the second locking joint d is bigger than a width of the first locking joint c, in this way, reduction of the diameter of the second annular hole b will be smaller than reduction of the diameter of the first annular hole a, bigger locking forces can be provided to the rod portion 122 inserted in the second connection ring 113 and the connection is promised to be reliable.

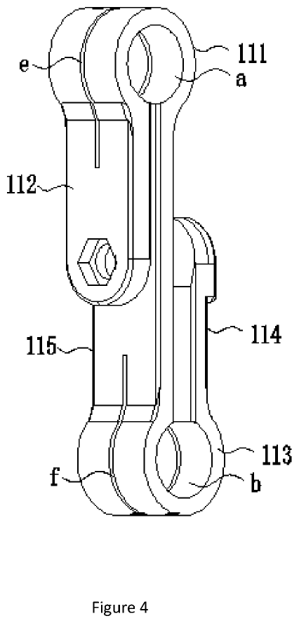

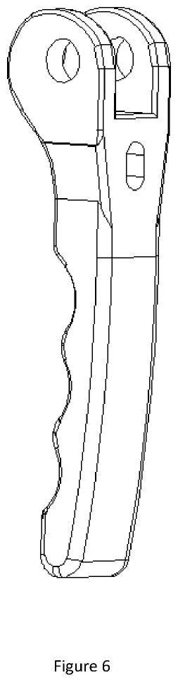

In an optional technical solution of the present embodiment, the link-lever assembly 100 comprises further a handle 130 and at least one connection screw 140; the at least one connection screw 140 passes sequentially the second pressing panel 114, the connection plate 115 and the first pressing panel 112, an axial line of the at least one connection screw 140 is vertical to a vertical line of the first connection ring 111 in a horizontal plane; one end of the handle 130 is hinged with an end of the at least one connection screw 140, a cam structure is provided at an end of the handle 130 hinged with the at least one connection screw 140, and the cam structure is abutted against the second pressing panel 114 as shown in FIGS. 4 and 6. Specifically, at least one nut is installed at an end of the at least one connection screw 140, and another end of the at least one connection screw 140 is connected with the handle 130. The second pressing panel 114, the connection plate 114 and the first pressing panel 112 are located in between the at least one nut and the handle 130.

When rotating the handle 130, a surface of the cam structure with a smaller diameter of the handle 130 is abutted against the second pressing panel 114, the first locking joint c and the second locking joint d are opened, in the meanwhile the third locking joint h is opened, at this time, the shafts inserted in the first connection ring 111, the second connection ring 11 and the ring portion 121 can rotate for 360° freely.

When rotating the handle 130 to abut a surface of the cam structure with a bigger diameter of the handle 130 against the second pressing panel 114, the handle 130 and the at least one nut are pressed against the first pressing panel 112 and the second pressing panel 114, so that widths of the first locking joint c and the second locking joint d are reduced, at this time, the rod portion 122 interpolated in the second connection ring 113 is pressed upon, the third locking joint h becomes smaller, and the shafts in the first connection ring 111, the second connection ring 113 and the ring portion 121 are locked and fixed. In this way, by rotating once the handle 130 through the dual-joint link-lever 110 three shafts can be locked at the same time, the three shafts comprise a shaft interpolated in the first connection ring 111, the rod portion 122 interpolated into the second connection ring 113 and the shaft interpolated into the ring portion 121, the number of elements is reduced, complexity and operation difficulty of the connection structures is reduced and operation time is saved.

Specifically, a locking hole 116 is provided in the dual-joint link-lever 110, as shown in FIG. 1, the locking hole 116 passes the second pressing panel 114, the connection plate 115 and the first pressing panel 112, and the at least one 140 is interpolated in the locking hole 116. A hexagonal hole is provided in the first locking panel, the hexagonal hole and the locking hole 116 are axially connected at a tail end portion of the locking hole 116, the at least one nut is provided in the hexagonal hole and can be engaged with the at least one connection screw 140. To prevent the handle 130 to fall off from the second pressing panel 114 after attachment, a mattress and a mattress protector are provided on the second pressing panel 114, and the mattress is interpolated in the mattress protector and is integral with the mattress protector. Both the mattress and the mattress protector are sleeved over the at least one connection screw 140, the mattress is abutted against the cam structure of the handle 130, and the mattress protector is abutted against the second pressing panel 114. By providing the mattress and the mattress protector friction between the handle 130 and the second pressing panel 114 is increased to prevent the handle 130 from rotating, loosening of the first locking joint c, the second locking joint d and the third locking joint h, and rotation or loosening of the shafts in the first connection ring 111, the second connection ring 113 and the ring portion 121.

Further, the link-lever assembly 100 comprises further a limiting pin 150, as shown in FIG. 4, the limiting pin 150 is inserted into the handle 130; the limiting pin 150 is slidably connected with the handle 130, and configured to be able to be interpolated into both the handle 130 and the at least one connection screw 140 to prevent the handle 130 from rotating, loosening of the first locking joint c, the second locking joint d and the third locking joint h, and rotation and even loosening of the shafts installed in the first connection ring 111, the second connection ring 113 and the ring portion 121.

### Embodiment 2

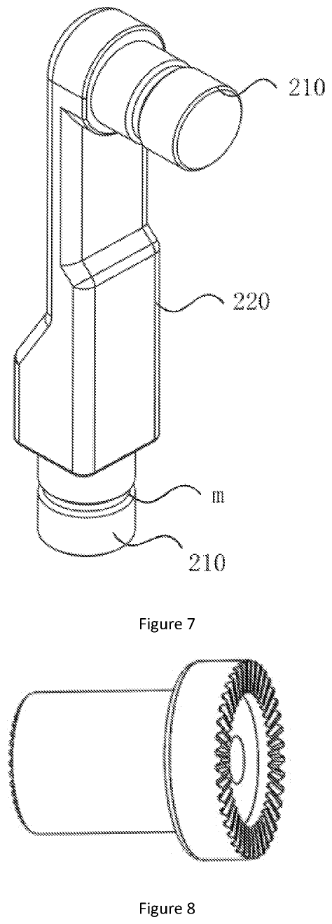

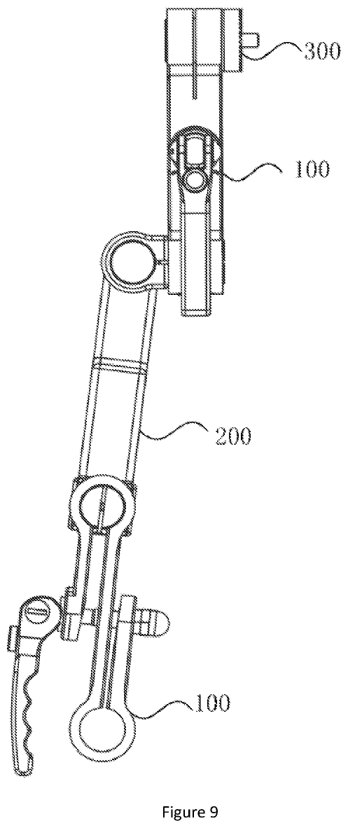

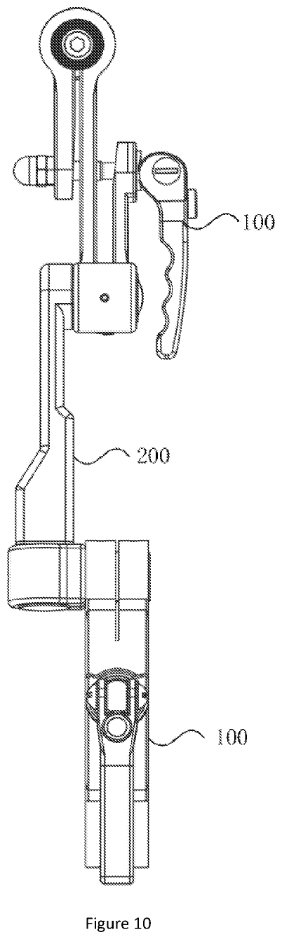

The embodiment 2 of the present invention provides a dual-joint link-lever fixing assembly, comprises the foregoing link-lever assemblies 100, and further comprises a steering column 200; as shown in FIGS. 7, 9 and 10, the steering column 200 is located in between two link-lever assemblies 100, and both ends of the steering column 200 are respectively connected with the two link-lever assemblies 100; connection shafts 210 are provided in both ends of the steering column 200, axial lines of the two connection shafts 210 are vertical to each other; and the two connection shafts 210 are respectively inserted into connection holes g of the two link-lever assemblies 100.

Specifically, the steering column 200 further comprises a connection handle 220, and the two connection shafts 210 are respectively provided at both ends of the connection handle 220. Further, the steering column 200 is made from aluminum alloy, to reduce weight and make it convenient to claim and operate it.

Further, at least one annular groove m is provided on the connection shafts 210, and threaded holes are opened on a side surface of the connection holes g; and fixing screws are installed into the threaded holes and inserted into the at least one annular groove m to realize location and prevent release of the connection shafts 210 from the connection holes g.

In the present embodiment, the dual-joint link-lever assembly comprises further a gear shaft 300; as shown in FIGS. 8-10, a side of the gear shaft 300 is inserted into the first connection ring 111 of one of the link-lever assemblies 100; a surface of another side of the gear shaft 300 is configured to be tooth-shaped, and configured to be connected with the U-shaped head frame; the first connection ring 111 of another of the link-lever assemblies 100 is configured to be connected with at least one supporting beam of the operational table.

When rotating the handles 130 and surfaces of the cam structures of the handles 130 with a smaller diameter is abutted against the second pressing panels 114, the first locking joints c, the second locking joints d and the third locking joints h are opened at the same time, the two link-lever assemblies 100 can respectively rotate against axial lines of the two connection shafts 210, the dual-joint link-lever 110 can rotate against axial lines of the rod portions 122, and the gear shaft 300 can pivot against axial lines of the first connection rings 111, all of the foregoing three structures can rotate for 360° freely, so that it is easy to adjust angles and positions of the U-shaped head frame of the gear shaft 300, which makes it convenient to use.

In the present embodiment, by connecting the steering column 200 and the two link-lever assemblies 100 random adjustment and locking of the two link-lever assemblies relative to each other can be realized. During use, by rotating the handles 130 on the two link-lever assemblies 100, fixing of all shaft-hole connections is done. For connection devices comprising the locking device, the toothed link-levers and rotational connectors, three operations of the handle are required to fix the assembly; however, with the dual-link-lever fixing assembly, by only turning the two handles 130, that is, by operating the handles 130 for two times, fixing is done, while operation time is saved, connection reliability of the assembly is improved and complexity reduced, less elements are used, which makes it convenient to maintain and use the assembly.

### Embodiment 3

The surgical head frame provided in the present embodiment comprises the foregoing dual-link-lever fixing assembly; one end of the dual-link-lever fixing assembly is connected with the U-shaped head frame and another end thereof is connected to the at least one supporting beam of the operational table through the first connection rings 111.

By connecting the U-shaped head frame with the operational table via the dual-link-lever fixing assembly, quick installation and dismantling of the U-shaped head frame is realized and it is convenient to adjust the angle and position of the U-shaped head frame.

Finally it shall be noted that: the foregoing embodiments are only used to explain the technical solutions of the present invention rather than limit the same; although a detailed description has been given to the present invention with reference to the foregoing embodiments, those of ordinary skill shall understand that: it is still possible to modify the technical solution recited in the embodiments of the present invention or replace with equivalents all or some of the technical features; and all the modifications and equivalent replacement shall not make the essence of the corresponding technical solution deviate from the scope of the technical solutions of the present invention.

1. A link-lever assembly, comprises a dual-joint link-lever (110) and a guiding rod (120), wherein the guiding rod (120) comprises a ring portion (121) and a rod portion (122);
the dual-joint link-lever (110) comprises a first connection ring (111), a first pressing panel (112), a second connection ring (113), a second pressing panel (114) and a connection plate (115);
the first connection ring (111) and the second connection ring (113) are provided at both ends of a longitudinal direction of the connection plate (115), and axially the first connection ring (111) and the second connection ring (113) are parallel;
the first pressing panel (112) is provided at a side of a thickness direction of the connection plate (115) and end portions of the first pressing panel (112) are connected with the first connection ring (111), a first locking joint (c) communicating with a first annular hole (a) of the first connection ring (111) is formed in between the first pressing panel (112) and the connection plate (115); the second pressing panel (114) is provided at another side of the thickness direction of the connection plate (115), and an end portion of the second pressing panel (114) away from the first pressing panel (112) is connected with the second connection ring (113), and a second locking joint (d) communicating with a second annular hole (b) of the second connection ring (113) is provided in between the second pressing panel (112) and the connection plate (115);
the first pressing panel (112) and the second pressing panel (114) are configured to drive diameters of the first annular hole (a) and the second annular hole (b) to be smaller after extruding by extruding forces in opposite directions;
at least one connection hole (g) is provided on the ring portion (121), a third locking joint (h) extending along an axial direction of the rod portion (122) is provided on the rod portion (122), and the third locking joint (h) is communicated with the at least one connection hole (g); the rod portion (122) is inserted into the second connection ring (113); the rod portion (122) is configured to make the third locking joint (h) to be smaller when being extruded and drive a diameter of the at least one connection hole (g) of the ring portion (121) to be smaller.

2. The link-lever assembly according to claim 1, wherein
a width of the first locking joint (c) increases gradually along a direction away from the first connection ring (111);
and a width of the second locking joint (d) gradually increases along a direction away from the second connection ring (113).

3. The link-lever assembly according to claim 2, wherein
a first annular joint (e) is provided circumferentially around the first connection ring (111), the first annular joint (e) separates the first connection ring (111) to be two ring bodies along a width direction;
and a second annular joint (f) is provided circumferentially around the second connection ring (113), and the second annular joint (f) divides the second connection ring (113) to be two ring bodies along a width direction.

4. The link-lever assembly according to claim 3, wherein
the link-lever assembly comprises further a handle (130) and connection screws (140);
the connection screws (140) pass sequentially the second pressing panel (114), the connection plate (115) and the first pressing panel (112), and axial lines of the connection screws (140) are vertical to an axial line of the first connection ring (111) in a horizontal plane;
one end of the handle (130) is hinged with ends of the connection screws (150), a cam structure is provided at an end wherein the handle (130) is hinged with the connection screws (140) and the cam structure is abutted to the second pressing panel (112).

5. The link-lever assembly according to claim 4, wherein
the link-lever assembly comprises a limiting pin (150), the limiting pin (150) is inserted in the handle (130);
the limiting pin (150) is slidably connected with the handle (130) and is configured to be able to be inserted simultaneously into the handle (130) and the connection screws (140) to prevent the handle (130) from rotating.

6. A dual-link-level fixing assembly, comprises the link-lever assemblies (100) as defined in claim 1, comprises further a steering column (200); wherein the steering column (200) is provided in between two link-lever assemblies (100), and both ends of the steering column (200) are respectively connected with the two link-lever assemblies (100);
connection shafts (210) are provided at both ends of the steering column (200), axial lines of the two connection shafts (210) are vertical;
and the two connection shafts (210) are inserted into connection holes (g) in the two link-lever assemblies (100).

7. The dual-link-level fixing assembly according to claim 6, wherein
at least one annular groove (m) is provided on the connection shafts (210), threaded holes (g) are opened at side surfaces of the connection holes (g);
and fixing screws are inserted into the threaded holes and inserted into the at least one annular groove (m).

8. The dual-link-level fixing assembly according to claim 7, wherein the dual-link-lever fixing assembly comprises further a gear shaft (300);
a side of the gear shaft (300) is inserted into the first connection ring (111) of one of the link-lever assemblies (100);
and a surface of another side of the gear shaft (300) is configured to be tooth-shaped and to be connected with a U-shaped head frame.

9. A surgical head frame, comprising the dual-link-lever fixing assembly as defined in claim 6; wherein
one end of the dual-link-lever fixing assembly is connected with the U-shaped head frame and another end thereof is connected with an operational table.
